(19) United States
(12) Patent Application Publication
(10) Pub. No.: US 2025/0182729 A1
(43) Pub. Date: Jun. 5, 2025

(54) META CELLS AND ACOUSTIC METAMATERIAL PANEL COMPRISING AT LEAST ONE ACOUSTIC META CELL

(71) Applicant: METADYNA MUHENDISLIK SANAYI VE TICARET ANONIM SIRKETI, Izmir (TR)

(72) Inventor: Tuba BAYGUN, Izmir (TR)

(73) Assignee: METADYNA MUHENDISLIK SANAYI VE TICARET ANONIM SIRKETI, Izmir (TR)

(21) Appl. No.: 18/841,684

(22) PCT Filed: Feb. 9, 2023
(86) PCT No.: PCT/TR2023/050120

§ 371 Date: Aug. 27, 2024

(30) Foreign Application Priority Data
Mar. 1, 2022 (TR) 2022/003002

(51) Int. Cl. G10K 11/162

(52) U.S. Cl. CPC G10K 11/162

(57) ABSTRACT

Meta cells can show both passive material and meta properties (ie, hybrid properties) and multifunctional acoustic metamaterial panel comprising at least one hybrid meta cell in order to decrease the transmission of sound waves and/or attenuate sound waves in a desired narrow or wide frequency band.

### CROSS REFERENCE TO THE RELATED APPLICATIONS

This application is the national phase entry of International Application No. PCT/TR2023/050120, filed on Feb. 9, 2023, which is based upon and claims priority to Turkish Patent Application No. 2022/003002, filed on Mar. 1, 2022, the entire contents of which are incorporated herein by reference.

### TECHNICAL FIELD

The invention is related to the development of meta cells which can show both passive material and meta properties (ie, hybrid properties) and multifunctional acoustic metamaterial panel comprising at least one hybrid meta cell in order to decrease the transmission of sound waves and/or attenuate sound waves in a desired narrow or wide frequency band.

### BACKGROUND

Sound or noise isolation/reduction/control basically takes place with two techniques, active and passive. In addition, this reduction or control is generally performed in two different ways, sound absorption and sound transmission loss. In terms of sound absorption, active and passive insulation can be described as:

Active insulation; in general, is carried out with a control sound wave interferencing with the source sound wave that is desired to be reduced without the application of an insulating material. Control sound wave is adjusted as in the opposite phase, and the same frequency of the sound wave desired to be suppressed. This method is quite costly. In addition, since it requires a controlled volume, its application area is limited in practice. In this method, the control sound wave can be produced externally using a sound source, or it can be produced without a sound source by means of various elements called resonators. However, this type of control can generally operate in narrow frequency bands (also known as tonal) and still needs a controlled volume. More resonators are needed to widen the frequency band. This means that the area where the resonators can be placed is increased. To absorb lower frequencies, larger volumes or lengths of resonators are required.

Passive insulation; is realized by placing the insulation elements, such as a sponge, felt, glass wool, rock wool, textile waste, etc., between the noise source and the receiver. Passive insulation materials provide sound absorption by viscous and thermal effects due to their internal spaces, discontinuities, physical and chemical structures. In addition to that, they can increase the propagation path of sound through the material (also known as tortuosity), thereby reducing the energy of sound waves that follow a longer path. These materials, which can absorb by converting sound energy into heat energy, are insufficient in absorbing low-frequency noises where the sound wave has a large wavelength. Because in order for these types of materials to function efficiently, the material characteristic thickness must be at least one quarter of the wavelength of the sound/noise to be controlled. For example, in order to absorb a 100 Hz sound wave (sound speed: 343 m/s), it requires the use of an insulation material with a characteristic thickness of 343/100/4≈86 cm. Since this is not possible both physically and economically in practice, this makes conventional materials not usable efficiently at low frequencies. In addition, the use of these materials in systems such as areas that require air circulation, food and hygiene equipment, flammable and hot environments is quite limited.

In terms of sound transmission reduction/loss, there is no difference between sound absorption or transmission for active isolation by nature. However, sound transmission loss can be realized by increasing the reflection with various acoustic volume-based geometric discontinuities (i.e. expansion chambers). Again, the need for larger volume continues at low frequencies.

When the sound transmission loss is evaluated in the context of passive control; it takes place depending on the material mass and frequency (known as the mass-frequency law). Accordingly, as the mass of the material increases, the sound transmission loss increases. Likewise, as the frequency increases, the sound transmission loss increases. Therefore, larger weights of insulating material must be used to achieve a higher sound transmission loss at lower frequencies. For this purpose, materials such as stone wool or glass wool reinforced concrete, and brick are generally preferred.

Especially in the last 15 years, there has been intense work on the development of artificial insulation materials, known as acoustic metamaterials, instead of traditional materials for low-mid frequency regions. Acoustic metamaterials have a wide range of uses, mainly in the technical field of physics and engineering, in many sectors such as automotive, aerospace, industrial machinery, white goods, household appliances, air conditioning and ventilation systems, defense industry, construction and construction sector. With acoustic metamaterials, high sound absorption and/or sound transmission loss can be achieved at certain singular low frequencies through negative effective mass, negative effective bulk modulus or both by not obeying the mass-frequency law. Cells are usually formed by periodically arranging them side by side or in succession. In these materials, although the material thickness is an important parameter; the main technique is to design and appropriately locate resonance cells which are usually of small size (having characteristic lengths smaller than the wavelength of sound., i.e. subwavelength). However, acoustic metamaterials, which are also in the state of the art, absorb in narrow frequency bands and provide transmission loss in a certain region (in a frequency band) depending on the resonance frequency of the cell. Therefore, it is necessary to develop acoustic metamaterials in order to provide a desired broad spectrum absorption and sound losses. Often a combination of multiple, tuned and periodically arrayed cells is used to broaden the band.

In the state of the art, in the patent with CN112728275 document no, it is mentioned that a sound absorption unit which is especially suitable for non-singular low-frequency noise absorption, has ultra-open ventilation and adjustable sound absorption performance. In this cell design; the frequency is adjustable, it allows air passage and it is aimed at sound absorption by trapping the sound wave in a labyrinth dead end. The cell mentioned in the document in question aims to increase the sound path for low frequencies so that it can absorb cavity resonances. The cell specified in this context may only feature a local negative Bulk module at singular but adjustable frequencies. In addition, a moving part inside can provide the frequency tuning (tuning) process. In this way, it has larger thicknesses by design. However, it does not have cell functions that can perform the sound transmission reduction, that is, have a negative mass effect.

In another known state of the art, in the patent with CN111883093 (A) document no., a 3-layer cell is mentioned as 1-micro-perforated plate, 2-double helix coiled structure, 3-back plate. In this cell type, the first plate comprises two micro-sized holes. Right behind these holes, there are two channels in the form of helix to increase tortuosity. With these two channels, it is aimed to provide absorption at two different frequencies at the same time. With the plate on the back, it is aimed to cut the transmission according to the law of mass. These two plates on the front and back do not show meta features. Sound attenuation is achieved through a micro-perforated front panel and a passively comprised dual channel. Again, it only works as a sound absorber at tonal frequency. Although the path is designed as a spiral in order to increase the tortuosity, the combination and metamaterial technique described in the mentioned document is a known technique.

In another known state-of-the-art, numbered WO2017093690A1, a unit cell of an acoustic metamaterial is mentioned. This cell provides high sound transmission at Fabry Perot frequencies with multiple additions of typical Helmholtz resonance cells. In other words, it is not a cell developed to reduce the transmission of sound waves created by a noise source and to absorb sound waves.

In another known state-of-the-art, US2021237394 (A1) patent document numbered; preserves another acoustic metamaterial. This metamaterial; a cell with a classical geometric form comprising a membrane consists of a posterior rigid cavity or a mass. This is a classical dipole type metamaterial. A classical metamaterial stops the sound transmission up to the natural frequency of its membrane. The metamaterial in question provides a small amount of sound absorption according to the material properties of the membrane. Therefore, according to the purpose, some of the said cells, which are counted in the state of the art, perform sound suppression and some perform sound absorption.

It is necessary to develop acoustic metacells that turn the disadvantages listed in the state of the art into advantages.

### SUMMARY

The purpose of the invention; comprising at least one part, which is both passive material and meta-feature (hybrid), developed with unique geometric forms to stop and/or absorb the transmission of sound waves by tuning to a desired narrow or wide frequency band, is to realize a multifunctional acoustic metamaterial panel comprising at least one acoustic hybrid metacell and said at least one hybrid metacell.

Another aim of the invention is the development of acoustic insulation panels that can be shaped or formed according to the applied section or place; the panels, comprising the aforementioned hybrid acoustic meta cells, can operate in the desired narrow band and/or a certain wide frequency band, can provide both high sound absorption and high sound transmission loss and they, can be very thin, flexible or rigid (inflexible, solid).

The developed cells and the panels comprising these cells can exhibit passive insulation material properties as well as acoustic metamaterial properties. For this reason, it is called hybrid acoustic meta cell and acoustic hybrid meta insulation panel/plate.

Besides, The cells also have a form that can function as a resonator at medium and high frequencies. Thus, a combined cell that can comprise both meta, passive material and resonator is obtained. In the state of the art, these features do not exist together in this way. These panels can be used in a wide range of sectors as sound (acoustic, noise) insulation materials.

In addition, since the insulation panels can be in perforated forms, innovative insulation systems that allow air circulation but not sound/noise transmission are created with the invention.

The cells of the invention show negative mass properties with a membrane or plate with a sub-wavelength, and a negative bulk modulus with cavities and channels (working like a special resonator with sub-wavelengths). These negativities imply metamaterial effects creating exotic behaviours leading to higher sound transmission loss and sound absorption. In addition, the geometry, thickness and length of the channels provide a high visco-thermal and tortuosity effects. These effects mean passive material behaviour. This hybrid combination is quite different from the systems mentioned in the state of the art. Thanks to these features, it can take a very thin form compared to the state of the art. Frequency tuning is performed with a calculation that comprises the geometric parameters of both the membrane/plate and the form of cavity, channel and slits.

The invention is a hybrid acoustic single cell in any geometric form, preferably circle, triangle, square, rectangular, polygon or arbitrary, which can be used in many sectors such as automotive, aviation, industrial machinery, white goods, household appliances industry, air conditioning and ventilation systems, defense industry, construction and building sector. These cells can create multicells by connecting single cells to each other through an acoustic volume channel. These cells are designed to stop the transmission in a very wide frequency range of sound waves created by a noise source or to provide sound absorption, with at least one first layer (or front or entrance layer) in any geometric form and physical feature, with at least one second layer (or intermediate layer) in any geometric form and physical feature, with at least one third layer (or output or back layer) of any geometric form and physical properties. These cells have at least one inner frame in any geometric form and physical properties, and at least one internal acoustic volume that fills the said inner frame as much as the inner volume and conforms to the geometric form of the inner frame or in any geometric form and physical properties. It also comprise at least one external acoustic volume channel of any geometric form and physical feature, positioned at a predetermined distance relative to the said inner frame and in the outer region of the inner frame, together with the acoustic volume. In addition, at least one outer frame in any geometric form and physical properties in the cell completely or partially covers a surface of the said external acoustic volume channel and said second layer of the said inner acoustic volume. Due to the geometrical form and physical feature formed by combining said first layer and said third layer, which completely or partially covers another surface, with the said second layer, two separate sections are formed in the cell for each of the first layer and the third layer at a predetermined thickness; first and second part. Each part exhibits different physical properties according to its natural frequencies.

### BRIEF DESCRIPTION OF THE DRAWINGS

FIG. 1 is a representative side view of the first layer, second layer and third layer that a metamaterial cell comprises.

FIG. 2 is an assembled three-dimensional perspective representation of the first layer, second layer and third layer comprised in a metamaterial cell, which is the subject of the invention.

FIG. 3 is a representative representation of the second layer in an embodiment of the invention.

FIG. 4 is a representative presentation of the sections that are formed spontaneously by combining the first layer and the third layer by placing them in front of and behind the second layer.

FIG. 5 is a disassembled representation of (a) first layer, (b) second layer, (c) third layer, which a metamaterial cell comprises.

FIG. 6 is the representative view of the single cell structure of the second layer with different geometric forms according to the embodiments of the invention.

FIG. 7 is the representative view of the binary cell structure of the second layer, which is brought together in two different forms in one embodiment of the invention.

FIG. 8 is the representative view of the single cell structure of the first layer and the third layer with different geometric forms according to the embodiments of the invention.

FIG. 9 shows that in an embodiment of the invention, the representation of the “e” path in the external acoustic volume channel of the second layer and the representation of the “h” section, which is the representation of the interior acoustic volume, is the symbolic representation.

FIG. 10 is the symbolic view of the panel comprising the additional protective layer (t) that creates a gap with the first layer and/or the third layer.

FIG. 11 is the graph of change of sound transmission loss according to frequency for H1 and H4 cell structures.

### EXPLANATION OF REFERENCES IN FIGURES

For a better understanding of the invention, the corresponding numbers in the figures are given below:

```
  1. Cell
    1.1 First layer
      1.10 Entrance hole
    1.2 Second layer
      1.20 Outer frame
        1.201 External acoustic volume channel
      1.21 Inner frame
        1.210 Interior acoustic volume
    1.3 Third layer
      1.30 Exit hole
A Mouth (Opening)
B1 First part
B2 Second part
t Protective Layer
```

### DETAILED DESCRIPTION OF THE EMBODIMENTS

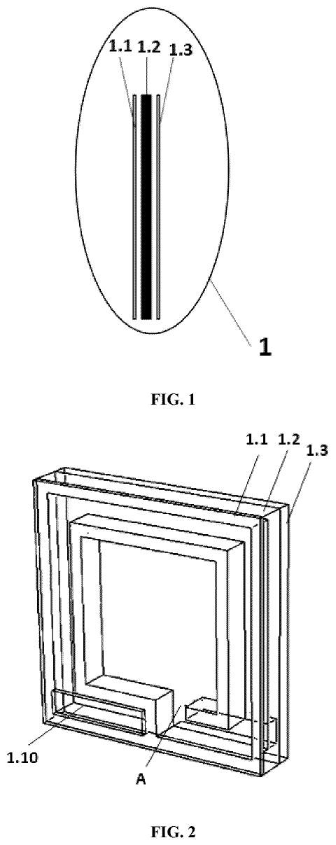

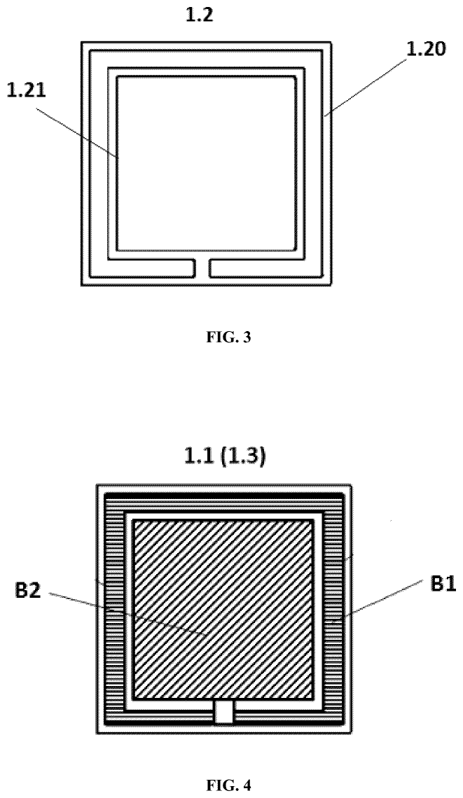

Hybrid single acoustic metacell (1), which is the subject of the invention, in order to stop the transmission and/or absorb the sound waves in a wide frequency range; It comprises at least one first layer (1.1) (or front or entrance layer) in any geometric form and physical properties, in order to be a resonant cell with characteristic dimensions smaller than the wavelength of the sound (i.e at subwavelength scale), at least one second layer (1.2) (or intermediate layer) in any geometric form and physical properties and at least one third layer (1.3) (or output layer or back layer) in any geometric form and physical properties (FIG. 1 and FIG. 2). The said hybridity is provided by the technical features arising from the combination of the three layers mentioned. In other words, the hybrid structure of the inventive cell (1) is obtained by combining both passive material properties and metamaterial properties. To summarize, passive material properties; while the channel formed inside is much longer than the material thickness (ie high tortuosity) and narrow channels are formed to provide visco-thermal effect, the metamaterial feature; the acoustic volume is achieved by adjusting the volume channel and membrane (or plate) created inside according to the frequency at lower wavelengths to obtain an effective negative mass and an effective negative Bulk modulus. In addition, it also has the form of an acoustic cellular space that can operate as a resonator at medium and high frequencies, using the A aperture as a neck. Therefore, a hybrid cell is obtained with all these. The hybrid cells (1), all or any part, can be produced from any material. A composite cell (1) structure was formed by combining the three layers mentioned above. The single cell (1) can be in any geometric form, circle, triangle, square, rectangle, polygon or any arbitrary (random, any) form (shape). The meta-cell (1) is the first layer that can be added together, the same and/or different, side-by-side and/or back-to-back and/or straight and/or diagonal and/or arbitrarily and/or periodically and/or randomly.

In order to realize another aim of the invention; Acoustic hybrid metamaterial insulation panels are formed by positioning at least one hybrid metamaterial cell (1) on top of and/or back-to-back and/or back-to-back and/or side-to-side and/or in any arbitrary manner. Therefore, the insulation panel comprises at least one hybrid metamaterial cell (1) that is positioned as desired and has different or the same geometric forms. Acoustic channels between cells can be connected to each other according to the desired frequency setting. Here, the term insulation comprises sound transmission stopping or sound absorption feature or both.

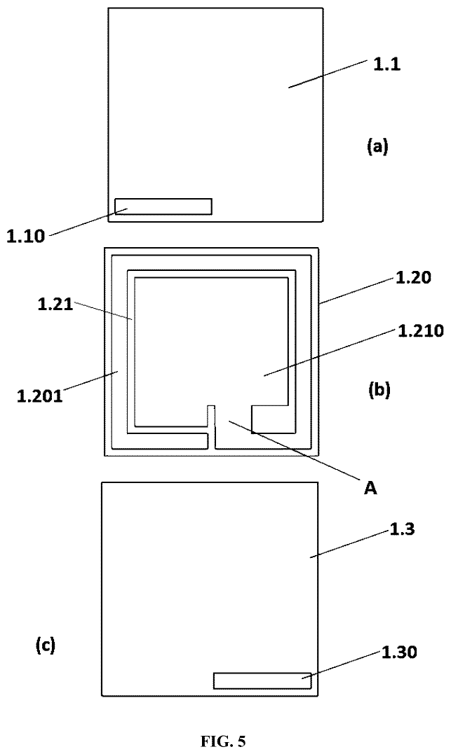

The second layer (1.2) of a predetermined thickness, an outer frame (1.20) of any geometric form (circle, square, rectangle or arbitrary) and inside said outer frame (1.20) conforming to the geometric form of the outer frame (1.20) or any comprises at least one inner frame (1.21) of any geometric form, positioned within the outer frame (1.20) and at a predetermined distance from the outer frame (1.20) (FIG. 3). Due to the geometric form of the second layer (1.2), the first layer (1.1) and the third layer (1.3) each act as two separate sections (B1 and B2). The partitions are formed spontaneously by combining the first layer (1.1) and the third layer (1.3) by placing them in front of and behind the second layer (1.2). These independent sections will be referred to as the first section (or peripheral membrane) (B1) and the second section (or middle membrane) (B2) (FIG. 4). The formation of the first part (B1) and the second part (B2) is valid in all embodiments of the invention. Sections B1 and B2 can also be subdivided according to the form of the inner and outer frame and how they are connected. Each of these sections is the elements of the metacell (1), which acts as an absorbing and conducting section separately depending on their natural frequencies.

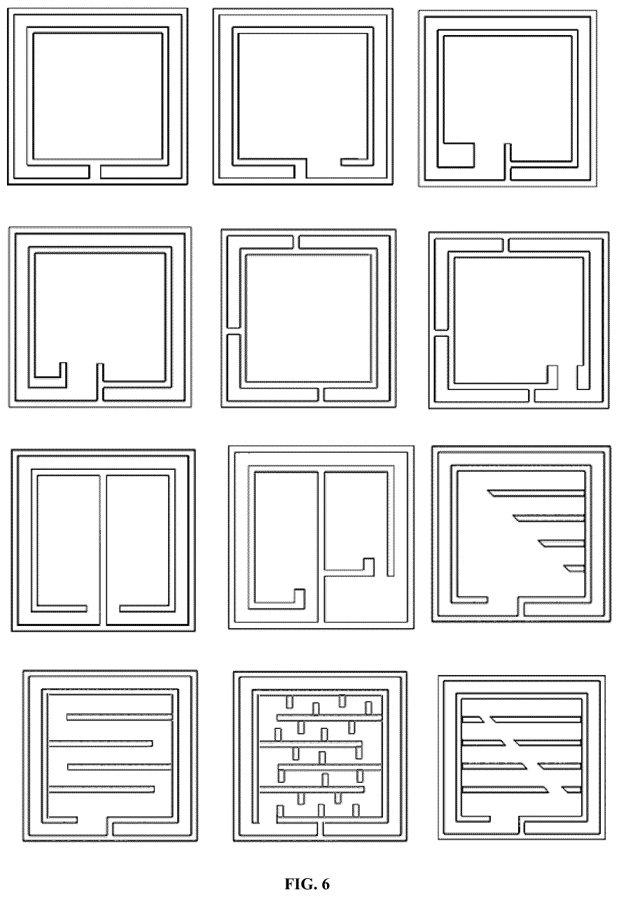

In an example implementation of this cell form (FIG. 5) if the outer frame (1.20) form is square, the inner frame (1.21) form may also be square, but it should not be considered limited to this in practice. As noted, both frames are intertwined and positioned to form a channel between them at a predetermined distance from each other. Therefore, in all embodiments of the invention, the outer frame (1.20) comprises at least one external acoustic volume channel (1.201) located in a region between itself and the inner frame (1.21) (i.e. the acoustic channel remains between the first sections (B1) of the 1st and 3rd layers.) In addition, the inner frame (1.21) comprises at least one interior acoustic volume (1.210) that fills the said frame as much as the interior volume (So the acoustic volume remains between the second sections (B2) of the 1st and 3rd layers.). In this application, an A-slit (opening, opening, neck, neck) is obtained by removing a predetermined height (length) and width piece in any desired section on the inner frame (1.21). With this slit, the internal acoustic volume (1.210) automatically forms a separate subwavelength inner metacell (1) of the type of a Helmholtz resonator. Here, the location of the A aperture and the neck length can be changed, and both the width and the length of the A aperture can be tuned at the desired frequency by creating the neck (1.210) of the acoustic volume (acting as a Helmholtz resonator). The internal acoustic volume (1.210) and the external acoustic volume channel (1.201) can be in any geometric form, preferably circle, triangle, square, rectangle, polygon or arbitrary (random, any) form (shape), but the applications are not limited to this. However, the inner frame (1.21) may comprise structures in a way to form a different number of channels and/or single or multiple slits (mouths) within the inner frame (1.21) in any form to be integral with itself or to be associated with the inner frame (1.21). FIG. 6). With these structures, the internal acoustic volume (1.210) comprised by the inner frame (1.21) can be in various geometric forms.

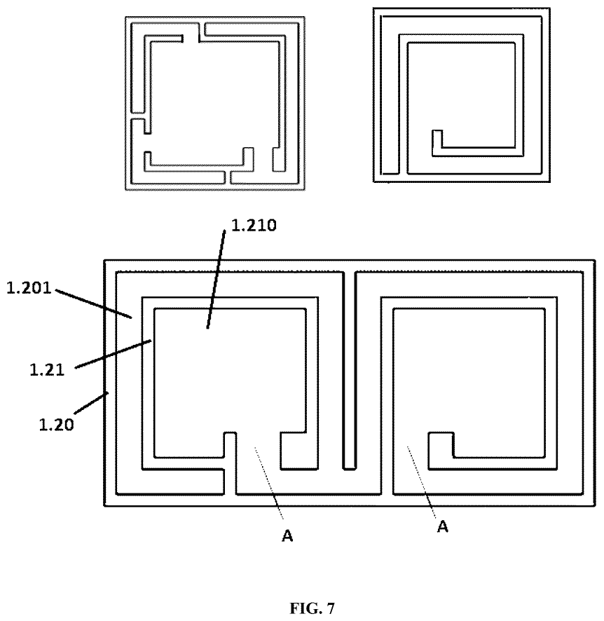

In different embodiments of the invention, each same or different metacell (1) can be connected to each other by acoustic volume channels (1.201) to form a new meta-cell (1) with double, triple or multiple and different acoustic characteristics. As an example of this application of the invention, two meta-cells (1) with different mouth openings in form and positions are connected to each other via acoustic volume channels (FIG. 7).

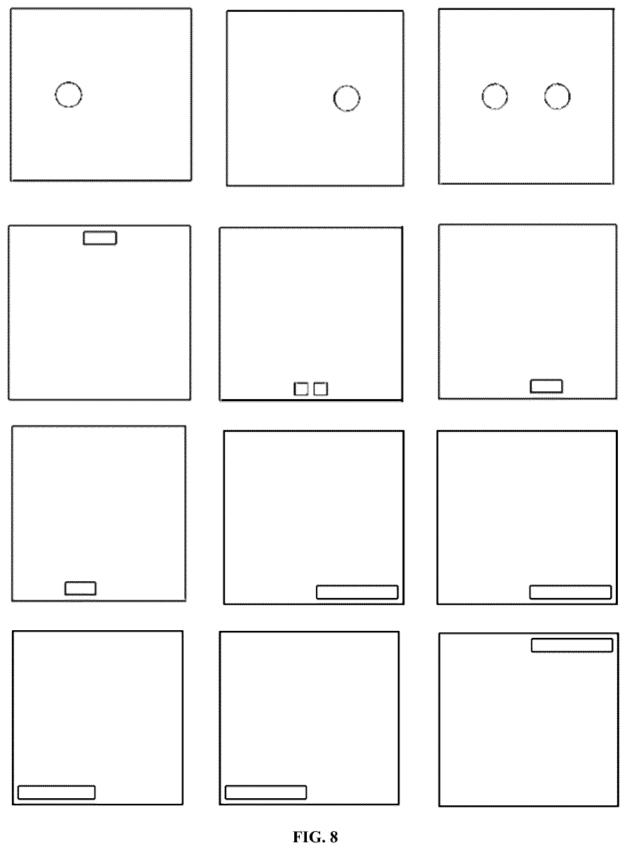

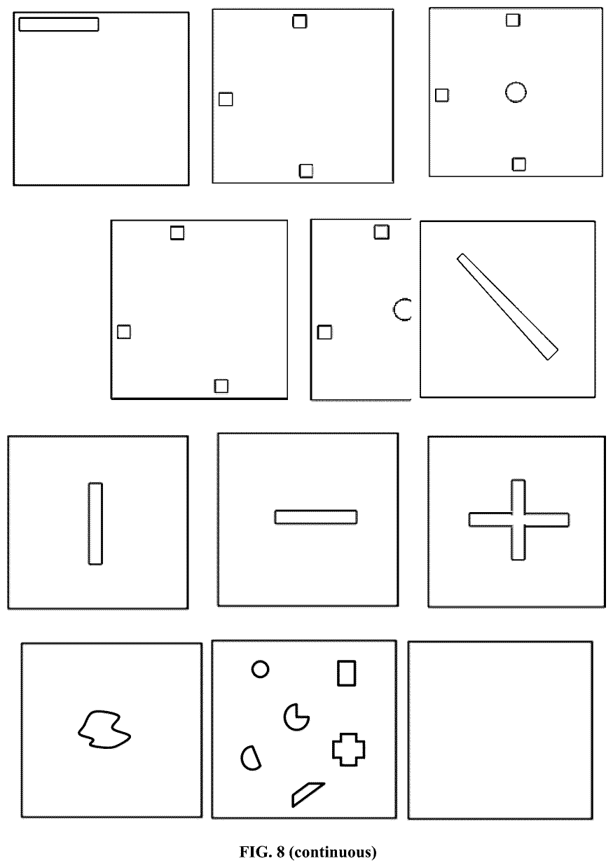

The first layer (1.1) and third layer (1.3); for entrance of sound wave (or air), respectively, according to embodiments of the invention; at least one entrance hole (1.10) in predetermined sizes, numbers, various geometric forms (circle, triangle, square, rectangle, polygon or arbitrary) and/or in predetermined sizes, numbers, depending on the cell character, depending on the cell character, may comprise at least one exit hole (1.30) in various geometric forms (circle, triangle, square, rectangle, polygon or arbitrary) (FIG. 8). If both holes are present in the cell (1), that is, if both the first layer (1.1) and the third layer (1.3) comprise holes, the cell (1) allows air inlet and outlet. Thus, hybrid metacells (1) that can stop (trap) sound transmission and provide ventilation are obtained with the invention.

The first layer (1.1), the second layer (1.2), and the third layer (1.3) have predetermined thicknesses and can be the same or different thicknesses. The first layer (1.1) and the third layer (1.3) may each be a membrane and/or plate according to embodiments of the invention.

On the first layer (1.1) and the third layer (1.3), a single, multiple or distributed mass or masses of any form and weight can be added to any part. The frequency region to be effective can be changed by changing the geometric dimensions, material, geometric shapes and the value and position of the mass brought on the first layer (1.1), the second layer (1.2) and the third layer (1.3).

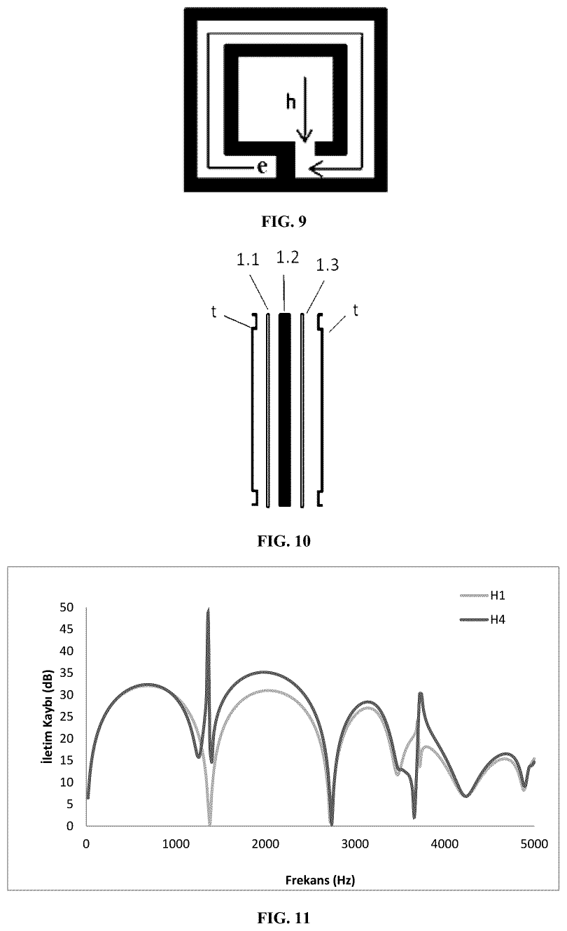

If the general working principle of the cells is summarized technically, the specially designed second layer (1.2) provides high absorption by increasing the tortuosity with the channel type space it comprises, allowing the sound to consume more energy than the thickness. This situation is shown as the “e” channel in FIG. 9. In addition, as a result of the narrowness of this “e” channel, an additional sound reduction is provided by friction and heat exchange losses, which are expressed as visco-thermal energy losses. The Helmholtz cell, which is defined as the “h” section, will create an additional sound absorption at a tonal frequency depending on its volume by emitting a sound wave in reverse phase, resonating with the sound wave that has reduced its energy through “e” by creating cavity resonance. This second layer (1.2) can be reformed in different forms as seen in FIG. 6 in order to provide the mentioned technical features in the desired frequency bands and desired insulation amounts.

Single cell (1); due to the inner frame (1.21) and the outer frame (1.20) and the small internal acoustic volume (1.210) between these frames and bounded by the membrane on both sides, it exhibits dipolar* properties and provides more than 50 percent sound at the natural frequency of the cell (1) and the volume. (*Note: cavities that do not comprise small closed volumes or comprise long volumes are monopole and provide absorption up to a maximum of 50 percent.)

The negative effective mass and the negative effective Bulk modulus can be provided simultaneously in the same frequency region by changing the geometry, material, shape and the physical properties of the inner frame (1.21), the outer frame (1.20), the inner acoustic volume (1.210), the outer acoustic volume channel (1.201), the first part (B1) (peripheral membrane) and the second part (B2) (middle membrane). In this way, double negative metamaterial can be obtained in a desired frequency band. When they are vibrated by the sound wave, it stops the propagation of the sound in a certain frequency region depending on the mass, if there is no mass on them, up to their natural frequency, if there is mass on them, it stops the propagation of the sound (it stops the transmission, creates a band gap, makes sound filtering). At the same time, a passive sound absorption occurs due to the elastic properties of the membranes.

The entrance hole (1.10) (or the wave entrance hole) located in the first layer (1.1) allows the sound wave to enter the cell and proceed through the acoustic volume channel (1.210). It is not necessary to have an exit hole in the third layer (1.3), it is determined by the desired character of the cell. As the path (L_{effective}) gets longer, the energy of the sound along the path is reduced. Thus, a significant amount of sound absorption is obtained. Therefore, absorption in the cell is increased. For this purpose, it is necessary to have at least one inlet hole (1.10) in order to provide impedance matching. However, the exit hole (1.30) need not always be. If a material that requires ventilation or does not block the air inlet and outlet is desired, there should be inlet and outlet holes (1.10 and 1.30). For example, in applications where air inlet and outlet are required, such as compressors or generators, metamaterials with cells with inlet and outlet holes (1.10 and 1.30) can be used to filter the sound (sound transmission stopping). The transmission and absorption spectrum of the cell (1) can be changed depending on whether each technical unit (such as the entrance hole (1.10), neck, internal acoustic volume (1.210) . . . ) comprised in the unit cell (1), which is the subject of the invention, is in the cell (1) or not. For example, the geometric form of the entrance hole (1.10) (circle, square or rectangle . . . etc) or even whether the said form exists or is positioned on the layer can completely change the behavior of the cell (1). As mentioned above, the first layer (1.1) and the third layer (1.3) can be at least one, as well as be made of membrane and/or plate of a predetermined thickness, or any material.

The cell (1) that is the subject of the invention functions as both a sound absorber and a sound transmission stopper due to its structure. That is, the first layer (1.1) or the second layer (1.2) or the third layer (1.3) alone cannot exhibit these features. However, the aforementioned features (absorption and transmission section) can only be realized with the cell (1) subject to the invention, when the first layer (1.1), the second layer (1.2) and the third layer (1.3) come together to form a combined structure.

The aim of the invention is to obtain a cell (1) structure that performs better sound absorption and sound transmission loss. For better absorption, the surface impedance should be reduced. At least one hole must be drilled in the first layer (1.1) to reduce the impedance. While doing this, the entrance hole (1.10) and/or the exit hole (1.30) should be opened in such a way as not to disturb the properties of the layers themselves. If an entrance hole (1.10) and/or exit hole (1.30) is opened in the middle of the cell (1), almost as large as the volume of the cell, the membrane does not show the desired vibration feature. The dimensions of the inlet hole (1.10) and/or the outlet hole (1.30) are made in such a way that they do not disturb the membrane (plate) feature. In addition, the mentioned holes allow the sound wave to enter and/or exit the cell, and with the predetermined geometric form, size and positioning, the path of the sound (L_{effective}) increases. In addition, the positioning of the holes is such that the sound travels the farthest path from the hole it enters to the hole where it exits. So thus a large effective length (L_{effective}) is created. Thus, the middle of the cell (1) functions like another membrane, and its surroundings work like another membrane. When sound or air enters from the inlet hole (1.10), the cell (1) shows a negative effective mass feature. As the sound progresses, the metamaterial begins to transform into a negative Bulk modulus. With the design of the cell (1) that is the subject of the invention, the air entering through the holes travels within the external acoustic volume channel (1.201), and the thickness of the material is extended at least 5 times in one application with the path taken by the sound. In other words, without the need for the material to be very thick, the conditions needed to reduce the energy of the sound are provided with the invention. In case of mouth opening, the internal acoustic volume (1.210) works like a Helmholtz resonator. Thus, the geometry of the cell (1) dampens the sound by showing a wave effect at a singular frequency, opposite to the sound, and can stop the sound propagation up to this frequency region. Therefore, the wave can be absorbed due to a phase difference (in opposite phase (180°)) of the wave at the same frequency. When a part of the wave is not passed, sound transmission loss occurs. However, when sound enters the cell and the sound is exposed to the specified geometry of the cell (friction increases when it is passed through a narrow channel), the energy of the sound is also reduced due to friction (heat exchange). Considering that a passive material provides absorption due to viscothermal effects, the cell (1) which is the subject of the invention, has this geometric form and the cell (1) begins to behave like a passive material. Therefore, as mentioned above, a hybrid material is formed by combining passive material and metamaterial.

The acoustic volume-based character of the metacell has a multifunctional feature according to whether there is an inlet hole (1.10) positioned on the mouth (A) and the first layer (1.1) in the second layer (1.2) (i.e, in the form layer) and an outlet hole (1.30) located on the third layer (1.30), and whether the neck connected to the mouth (A). Thus, different meta-cells (1), whose character can be easily changed, are obtained depending on whether there is only a hole/neck/mouth, depending on the application area. Some combinations showing the acoustic volume-based sound transmission loss character of these metacells (1) can be seen in Table 1.

TABLE 1
Example meta cells (1)

| | | | | Acoustic volume-based |
|---|---|---|---|---|
| Cell (1) | Mouth | Entry Hole | Exit Hole | sound transmission loss |
| type | (A) | (1.10) | (1.30) | character of metacell |
| H1 | No | Yes | Yes | Expansion chamber |
| H2 | No | Yes | Yes | Quarter wave resonator |
| H3 | Yes | Yes | No | Quarter wave resonator + |
| | | | | Helmholtz Resonator |
| H4 | Yes | Yes | Yes | Expansion chamber + |
| | | | | Helmholtz Resonator |

An example description for Table 1:

In an application of the invention, if there are holes in the first layer (1.1) and the third layer (1.3) that the cell (1) comprises, that is, if an entrance hole (1.10) and an exit hole (1.30) are located in both layers (H1), the entire acoustic space will have the character of an expansion chamber. While only the inlet hole (1.10) is present, the meta cell (1) turns into a quarter-wave resonator (H2). While the inlet (A) is present, an additional Helmholtz resonator is formed in the cell (1) (H3 and H4).

In FIG. 11, the behaviors of H1 and H4 cells are given as an example. The frequency, c/(2L_{effective}), that minimum transmission loss occurs in H1 can be adjusted by the frequency of the acoustic volume (6) by changing the width, length, height and size of the internal acoustic volume (1.210) and the inlet opening (A), (since the volume work like a Helmholtz resonator), and thus high transmission loss is achieved at this frequency:

$${f}_{HR} = c / ( 2 {L}_{effective} ) ( c : speed of sound , {L}_{effective} : effective path ( length )$$

In summary, the long and narrow external acoustic volume channel (1.201); By providing high tortuosity, it provides higher absorption at lower frequencies. However, the sound wave entering from the inlet hole (1.10) travels a longer distance than the channel thickness and is exposed to higher visco-thermal effects as it travels inside the cell (1). This allows the sound wave to consume more of its energy and thus the cell has a higher sound absorption capacity. This feature makes the meta cell a hybrid cell. As the viscous absorbance increases, the frequency band becomes wider. With the use of multiple and different cells, the panel comprising hybrid cells having a feature that can provide absorption in a wider band.

In addition to what has been described, the same or different single cells (1) can be connected to each other in double, triple, quadruple and multiple, side-by-side, back-to-back or back-to-back or any other arrangement according to the purpose. Thus, higher absorption is obtained at lower frequencies. All individual cells (1) are binary (for example, FIG. 7), and multiple cells (1) can have a circle, triangle, square, rectangle, polygon, or arbitrary shape. In binary and multiple cells (1), additional behaviors are obtained to the properties and characteristics obtained in single cells (1). By creating two or more Helmholtz resonators by means of two or more acoustic volumes and inlets (A), dual or multiple resonance cells (1) are provided. Thus, sound absorption and sound transmission loss are obtained in dual and multiple tonal frequencies. Again, as in single cells (1), different sound absorption and transmission loss characteristics are obtained according to the open and closed combinations of the inlets (A). In double and multiple cells (1), the intercellular path is connected to each other for a longer effective path (L_{effective}). This results in higher sound energy absorption at lower frequencies.

The first layer (1.1), the second layer (1.2), and the third layer (1.3) are joined to each other by any available bonding method, forming single or multiple cells (1). All cell layers can be produced by any fabrication method, such as a single piece or a composite structure.

On the other hand, panels that absorb at various frequencies can be formed by placing at least one of these same or different cells (1) side by side (or by sequential ordering) or on top of each other, or in any arrangement according to the purpose. In order to form a panel, at least one cell (1) mentioned in the same or different geometric form and physical properties can be positioned on the said panel. Thus, panels consisting of meta-cells (1) that are the subject of the invention can be obtained. Since the panel comprises at least one meta cell (1) and each cell (1) will be placed on the panel in such a way as to absorb the sound of the same or different frequencies, sound absorption will be realized in both tonal and wide bands.

The features of the panels obtained from the metacells (1) that are the subject of the invention are as follows:
1—Panels can be constructed by the addition of the same and/or different, single or multiple hybrid cells (1) to each other by side by side and/or back to back and/or straight and/or diagonal and/or arbitrarily and/or periodic and/or random and/or by a different sequence according to the desired purpose.
2—The same or different panels formed by having one or more cells (1), side by side and/or back to back and/or straight and/or diagonal and/or arbitrarily, periodically and/or randomly and/or, depending on the desired purpose, they can be combined with each other with a different arrangement to create a product in any 2 dimensional or three dimensional form.
3—Insulation products formed with panels and/or hybrid metacells (1), by gluing and/or attaching and/or snapping and/or any bonding/adhesive/joining/attaching to each other or to any element, partially or completely can be built in an integrated manner.
4—Panels can be rigid, hard, soft or flexible according to the material used and can be given an arbitrary form. Thus, the product produced from the panels can likewise be rigid, hard, soft or flexible and can be given an arbitrary form.
5—The main material of these acoustic metamaterial panels can be produced from combinations of the most suitable materials (such as metal, wood, plastic, foam, plexiglass, PVC, etc.) selected according to the system to be applied and its purpose. That is, the layers of the cells (1) that the panels have can be manufactured from the same or any different material by choosing the most suitable for the purpose. The cells (1) that make up the panel can be produced singly or as a single piece in multiple ways. In the preferred application of the invention, the panels are manufactured from any additive or pure material to be suitable for any flammability and/or any safety class.
6—The panels can be of different thickness depending on the cell's thickness (1).
713 Panels and/or cells (1) can have a circle, triangle, square, rectangle, polygon or arbitrary form.
8—The panels and/or cells (1) may comprise at least one additional protective layer (t) (plate or layer or cover) that creates a gap with the first layer (1.1) and/or the third layer (1.3). (FIG. 10). These layers allow the sections (membranes/plates) to vibrate freely by cutting off the direct contact of the first sections (B1) and second sections (B2) with the application surface during the application (adhesion, bonding) of the panel to any surface. In addition, the first section (B1) and the second section (B2) protect the cell (1) from dust, dirt, penetrating and cutting tips, heat, chemical reactions, corrosion, rain, moisture, living creatures and all internal and external factors that may occur and prevent deterioration. Therefore, the panels can be protected with a layer not only when they are attached to the surface, but also due to the factors mentioned.
9—While designing the panels as a layered composite structure creates ease of production, it will not occupy too much space in the application areas due to its very thin structure. However, in terms of production, panels can be produced as a single piece with any production method. The panels in question can be specially designed according to the criteria of high performance, ease of production and low cost.

In summary, the insulation panels formed with metacells (1), which are the subject of the invention, are designed according to the acoustic metamaterial theory. Acoustic metamaterial is simply a kind of artificial composite structure, single or multi-layered, formed by combining one or more base materials by converting them into subwavelength resonance cells. Space and/or vibrating thin plates and/or small weights are placed in the first layer (1.1) and third layer (1.3) of this structure in a planned manner. On the other hand, the geometry, form and dimensions of the second layer (1.2) are specially designed according to the frequency character of the noise to be reduced. When the sound wave of the noise hits this three-layer structure, it vibrates and resonates with this specially tuned three-layer structure. The resonating first layer (1.1), the second layer (1.2), and the third layer (1.3) and the special structure formed by their combination will show a negative mass and/or Bulk Modulus effect up to their resonance frequencies, which will stop the sound propagation in this region and absorb sound energy, thus reduce the sound level to a certain amount. In this way, noise absorption and/or noise transmission stopping is realized with the cell (1), which is the subject of the invention. As it can be understood, the working mechanism of such structures is completely different from that of passive insulation materials. While passive insulation materials provide absorption by converting sound energy into heat energy, these structures reduce sound energy by preventing and manipulating the propagation of sound with cells at lower wavelengths.

In addition to showing acoustic metamaterial properties, the obtained panels perform both sound transmission and sound absorption at the same time in a wider frequency band by taking advantage of the properties of passive materials. That's why it's called a hybrid. Panel cells (1), specially designed and brought to the most optimum form with R&D activities, will operate with maximum efficiency in the wide frequency band of 50 Hz-20000 Hz.

### Application of the Invention to Industry

The invention is metamaterial panels comprising at least one cell (1) developed for use in many sectors such as automotive, aerospace, industrial machinery, white goods, household appliances industry, air conditioning and ventilation systems, defense industry, construction and construction industry, and is industrially applicable.

The invention is not limited to the above exemplary embodiments, a person skilled in the art can easily demonstrate different embodiments of the invention. These should be considered within the scope of the protection claimed by the claims of the invention.

What is claimed is:

1. A meta cell, which is suitable to be used in many sectors such as automotive, aviation, industrial machinery, white goods, household appliances industry, air conditioning and ventilation systems, defense industry, construction, and building sector; preferably a circle, triangle, square, rectangle, polygon or arbitrary (random, any) form (shape) in any geometric form that can be connected to each other via a hybrid acoustic single or an acoustic volume channel, comprising:
at least one layer for stopping transmission and/or absorption of sound/noise waves created by a noise source in a very wide frequency range,
at least one first layer (or front or entrance layer) of any geometric form and physical feature,
at least one second layer (or intermediate layer) of any geometric form and physical feature,
at least one third layer (or exit or back layer) of any geometric form and physical feature,
at least one interior frame having any physical feature integral with itself or any geometrical form associated with it and comprising structures to form a different number of channels (or slits) therein,
at least one interior acoustic volume having any geometric form and physical properties that fills the interior frame as much as its interior volume and conforms to the geometric form of the interior frame, wherein;
the interior having any geometry positioned at a predetermined distance from the interior frame and in the outer region of the interior frame so as to form a channel between it and the interior frame, comprising at least one external acoustic volume channel in any form and physical properties and at least one outer frame in any geometric form and physical properties, that wherein the external acoustic volume channel and the internal acoustic volume) by combining the first layer to completely or partially cover one surface of the second layer and the third layer to cover another surface completely or partially according to purpose, with the second layer, at least one first section and at least one section of at least two separate sections of each of the first layer and the third layer at a predetermined thickness, due to geometric form and physical properties of all layers; the second layer of a predetermined thickness, which enables it to act as a second portion and wherein the first layer, second layer and third layer are positioned at a predetermined distance.

2. The meta cell according to claim 1, wherein the first layer and the third layer are membrane and/or plate.

3. The meta cell according to claim 2, wherein mass is added on the first layer and the third layer to any part, in any form and weight, and position.

4. The meta cell according to claim 3, wherein the internal acoustic volume and the external acoustic volume channel are in any geometric form, preferably a circle, triangle, square, rectangle, polygon or any arbitrary (random, any) form (shape).

5. The meta cell according to claim 4, wherein the first layer and the third layer comprise at least one inlet hole for the wave to enter and at least one exit hole for the wave to exit, with the hole dimensions are determined in a way that the holes do not disrupt the membrane (plate) feature, the holes allow the sound wave to enter and/or exit the cell thus increase the effective length (path) (L_{effective}) with predetermined geometric form, size and positioning.

6. The meta cell according to claim 5, wherein at least one entrance hole and/or at least one exit hole are in various geometric forms (circular, triangular, square, rectangular, polygon or arbitrary), sizes and are positioned anywhere on the layer they are in, depending on the character of the cell.

7. The meta cell, according to claim 6, wherein at least one second layer comprises at least one mouth (A) (or opening) connecting the external acoustic volume channel and the internal acoustic volume.

8. The meta cell, according to claim 7, wherein the first layer, the second layer, and the third layer are added to each other side by side and/or back-to-back and/or straight and/or diagonally and/or arbitrarily and/or periodically and/or randomly.

9. A panel, comprising at least one meta cell according to claim 1, wherein the identical and/or different cells are interconnected side by side and/or back-to-back and/or straight and/or diagonal and/or arbitrarily and/or periodically and/or randomly.

10. A product, wherein the meta cell according to claim 1 and a panel are attached to each other or to any element by gluing and/or snapping and/or fitting and/or by any method of fastening/gluing/joining/attaching and/or are formed partially or fully integrated.

11. The product according to claim 10, wherein the cell and/or panel having a circle, triangle, square, rectangle, polygon, or arbitrary form can be of different thicknesses depending on the same or different cell thicknesses, which can be formed by combining them side by side and/or back to back and/or straight and/or diagonal and/or arbitrarily, periodically and/or randomly.

12. The product according to claim 10, wherein the cell and/or panel comprises at least one additional protective layer (t) (plate or layer or cover) forming a space with the first layer and/or the third layer.

13. The panel according to claim 9, wherein the first layer and the third layer are membrane and/or plate.

14. The panel according to claim 13, wherein mass is added on the first layer and the third layer to any part, in any form and weight, and position.

15. The panel according to claim 14, wherein the internal acoustic volume and the external acoustic volume channel are in any geometric form, preferably a circle, triangle, square, rectangle, polygon or any arbitrary (random, any) form (shape).

16. The panel according to claim 15, wherein the first layer and the third layer comprise at least one inlet hole for the wave to enter and at least one exit hole for the wave to exit, with the hole dimensions are determined in a way that the holes do not disrupt the membrane (plate) feature, the holes allow the sound wave to enter and/or exit the cell thus increase the effective length (path) (L_{effective}) with predetermined geometric form, size and positioning.

17. The panel according to claim 16, wherein at least one entrance hole and/or at least one exit hole are in various geometric forms (circular, triangular, square, rectangular, polygon or arbitrary), sizes and are positioned anywhere on the layer they are in, depending on the character of the cell.

18. The panel according to claim 17, wherein at least one second layer comprises at least one mouth (A) (or opening) connecting the external acoustic volume channel and the internal acoustic volume.

19. The panel according to claim 18, wherein the first layer, the second layer, and the third layer are added to each other side by side and/or back-to-back and/or straight and/or diagonally and/or arbitrarily and/or periodically and/or randomly.

20. The product according to claim 10, wherein the first layer and the third layer are membrane and/or plate.
